(19) United States
(12) Patent Application Publication
(10) Pub. No.: US 2003/0149768 A1
(43) Pub. Date: Aug. 7, 2003

(54) System and method for reflective system and network performance assessment and verification

(76) Inventor: Shaun Charles McNerney, Colorado Springs, CO (US)

Correspondence Address: Law Office of Dale B. Halling, LLC, Suite 311, 24 South Weber St., Colorado Springs, CO, 80903, US

(21) Appl. No.: 10/358,666

(22) Filed: Feb. 5, 2003

Related U.S. Application Data
(60) Provisional application No. 60/354,844, filed on Feb. 6, 2002.

(51) Int. Cl. G06F 15/173

(52) U.S. Cl. 709/224; 709/226

(57) ABSTRACT

A system for reflective system and network performance assessment and verification includes a number of computer systems each running an assessment and verification process. A data network is coupled to each of the plurality of computer systems. A reflective monitoring process runs on a computer system and is coupled to the data network. The reflective monitoring process transmits a test and measurement information to one of the assessment and verification processes.

### RELATED APPLICATIONS

This patent claims priority on the provisional patent application entitled “System and Method for Reflective Monitoring of Networked Computer Systems and Services”, filed on Feb. 6, 2002, and having application No. 60/354,844.

### FIELD OF THE INVENTION

The present invention relates generally to the field of computer software and more particularly to a system and method for reflective system and network performance assessment and verification.

### BACKGROUND OF THE INVENTION

The number of corporations and individuals that use computer systems and connect their computer systems to data networks and to the Internet continues to rapidly grow. This growth in computer systems and data networks has resulted in the introduction of and the reliance on a growing number of services provided via data networks. This growth has resulted in a significant number of users with little to no technical experience on how the computer system or data network operates. This growth has also triggered an increase in the complexity of data networks which means that a greater number of combinations and permutations need to be tested and monitored to know if everything is operational and working for an end-user to be able to accomplish their desired/required tasks.

The main objective of testing and monitoring is to determine if the resources required to complete required tasks are available and operational. The present products directed to this problem use a centralized approach. Unfortunately, a centralized system cannot determine from an end user's point of view if the various network based resources are available and operational.

Thus there exists a need for a system that provides reflective system and network performance assessment and verification.

### SUMMARY OF INVENTION

A system for reflective system and network performance assessment and verification includes a number of computer systems each running an assessment and verification process. A data network is coupled to each of the plurality of computer systems. A reflective monitoring process runs on a computer system and is coupled to the data network. The reflective monitoring process transmits a test and measurement information to one of the assessment and verification processes. In one embodiment, the system has a group test and measurement information and the test and measurement information is transmitted to the group test and measurement information. The group test and measurement information then distributes the test and measurement information to the various assessment and verification processes. In one embodiment, one of the assessment and verification processes has a requirement to test a data network connection periodically. This requirement includes a maximum time between direct tests. In another embodiment, the assessment and verification processes receives a reflective test result from the reflective monitoring process via the group assessment and verification process.

In one embodiment, the assessment and verification processes performs a direct test and transmits a result to the reflective monitoring process via the group assessment and verification process. In another embodiment, the reflective monitoring process performs a direct test and transmits the result to the assessment and verification processes via the group assessment and verification process.

In one embodiment, the test and measurement information includes a server test.

In one embodiment, a system for reflective system and network performance assessment and verification includes a networked computer system with a first computer system running an assessment and verification process. A networked computer system has a second computer system running a group assessment and verification process. A reflective monitoring process runs on a third computer and is coupled to the networked computer system. The reflective monitoring process performs a test on the networked computer system and transmits a test result to the assessment and verification process via the group assessment and verification process. In one embodiment, the test is database server test.

In one embodiment, the assessment and verification process has a network testing requirement that includes a reflective test limit. In another embodiment, the assessment and verification process performs a direct test and reports a direct test result to the reflective monitoring process via the group assessment and verification process.

In one embodiment, the networked computer system includes a number of computers each running an assessment and verification process. In another embodiment a second networked computer system is coupled to the reflective monitoring process. In another embodiment, a second reflective monitoring process is coupled to the networked computer system.

In one embodiment, a process for reflective system and network performance assessment and verification includes the steps of selecting a task from a configuration file by an assessment and verification process at a first computer. Next it is determined if the task requires a direct test. When the task does not require the direct test, a reflective result is received from a reflective monitoring process running on a second computer. When the task does require the direct test, the direct test is performed to form a direct result. The direct result is transmitted to the reflective monitoring process which runs on the second computer.

In one embodiment, an elapsed time since a last direct test is determined. When the elapsed time is greater than a predetermined time, the direct test is required. When the elapsed time is not greater than a predetermined time then the direct test is not required.

In one embodiment, a test is performed by the reflective monitoring process. The reflective result of the test is transmitted to the assessment and verification process.

### BRIEF DESCRIPTION OF THE DRAWINGS

FIG. 1 is a block diagram of a system for reflective system and network performance assessment and verification in one embodiment;

FIG. 2 is a schematic diagram of the tasks performed by an assessment and verification process in one embodiment of the invention;

FIG. 3 is a diagram of a group assessment and verification process coupled to assessment profiles in accordance with one embodiment of the invention;

FIG. 4 is a block diagram of a system for reflective system and network performance assessment and verification in accordance with one embodiment of the invention; and

FIG. 5 is a flow chart of the steps used in a method for reflective system and network performance assessment and verification in accordance with one embodiment of the invention.

### DETAILED DESCRIPTION OF THE DRAWINGS

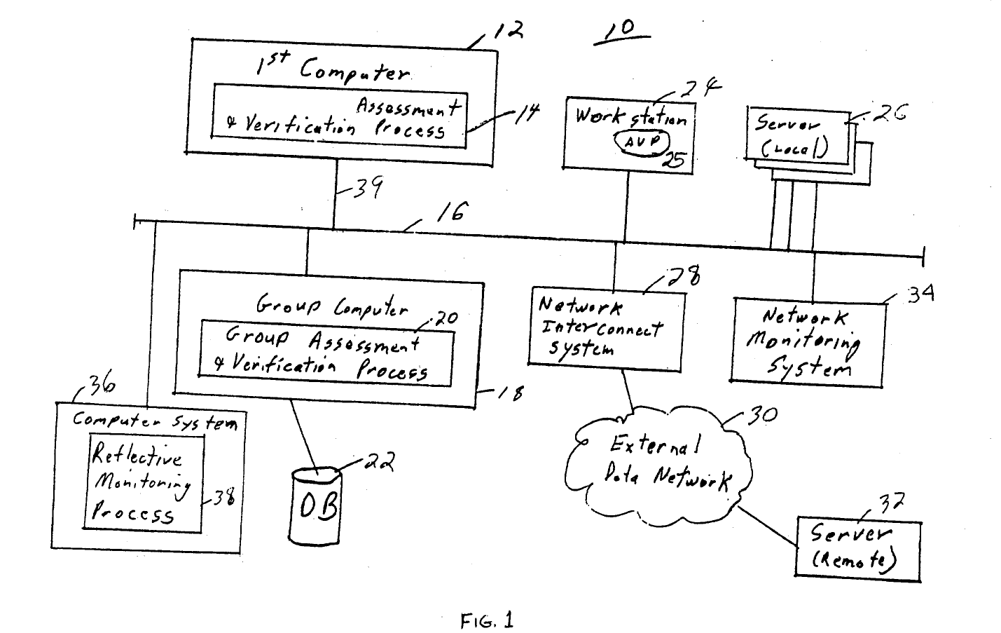

FIG. 1 is a block diagram of a system for reflective system and network performance assessment and verification 10 in one embodiment. The system 10 has a first computer 12 which runs an assessment and verification process 14. The first computer 12 is coupled to a data network 16. A group computer or second computer 18 is also coupled to the data network 16. A group assessment and verification process 20 runs on the group computer 18. A database 22 is coupled to the group computer 18. A workstation 24 is coupled to the data network 16 and runs the assessment and verification process (AVP) 25. In one embodiment a number of local servers 26 are coupled to the data network 16. Each of the local servers may have the assessment and verification process running. A network interconnect system 28 couples the data network 16 to an external data network 30 (e.g., the Internet). A remote server 32 may be attached to the external data network 30. The remote server 32 may have the assessment and verification process running. In one embodiment, a network monitoring system 34 is coupled to the data network 16.

The first computer system 12 has a number of system resources such as processes, services, CPU, memory, storage, software modules, software applications and others. In addition, the first computer system 12 has a number of network resources such as network software, network drivers, network interface, cabling, connectors, connection status, speed, link quality, errors and others. All these system and network resources need to be assessed and verified. Each of the other computer systems 18, 24, 26, 28, 32 have similar system and network resources that need to be assessed and verified. The assessment and verification processes 14, 25 are used to check these resources and make sure they are available and operational within the required limits when an end user needs them to accomplish their job. Each of the assessment and verification processes 14, 25 report assessment and verification information to the group assessment and verification process 20. The group assessment and verification process 20 aggregates, stores and acts on this information. For instance, each of the assessment and verification processes may be reporting that an email server is down. The group assessment and verification process will send a message to the assessment and verification processes and direct them to stop testing the email server's availability for a certain period of time. The assessment and availability information is reported to an end user. The report is in text form and may also include a visual, auditory or other sensory indicators. The database 22 also contains a plurality of assessment profiles. In one embodiment, there is an assessment profile for each of the computer systems. In another embodiment, there is an assessment profile for each user of the computer systems. The network monitoring system 34 is a legacy system that receives assessment data from the group assessment and verification processes 20.

Another computer system 36 is also coupled to the network 16. A reflective monitoring processes 38 runs on this computer 36. As the system 10 adds multiple computers and systems the amount of traffic on the network devoted to assessment, verification and testing increases significantly. The reflective monitoring process 38 is used to reduce this network traffic. An example of how this works is the first computer 12 and the workstation 24 both need to check the availability of a file server 26. The reflective monitoring process 38 performs a direct test from computer system 36 to determine the availability of the file server 26. The result of this test is transmitted to the group computer 18 which then transmits it to the first computer 12 and the workstation 24. Thus the assessment and verification process (AVP) 14 receives a reflected result from the reflective monitoring process. The reflected result tests the exact same connections as the AVP 14 except for the leg 39. As a result the AVP 14 only needs to directly test the network leg 39. When there are numerous computers all checking this connection, this process significantly reduces the amount of network traffic.

In one embodiment, the AVP 14 has a maximum time period that it may rely on reflected tests. For instance, the AVP 14 may have a requirement to test the connection to the file server 26 every two minutes and a reflective time limit of one hour. The AVP 14 would then check to determine when the previous direct test occurred. When the previous direct test by the AVP 14 was more than one hour ago, then the AVP 14 would initiate a direct test of the connection to the file server 26. In one embodiment, the AVP 14 would transmit the results of the direct test to the reflective monitoring process 38. The reflective monitoring process 38 may then transmit these results to the AVP 25 to provide reflective results for the AVP 25. As a result, the reflective monitoring process 38 significantly reduces the network traffic for large computer networks.

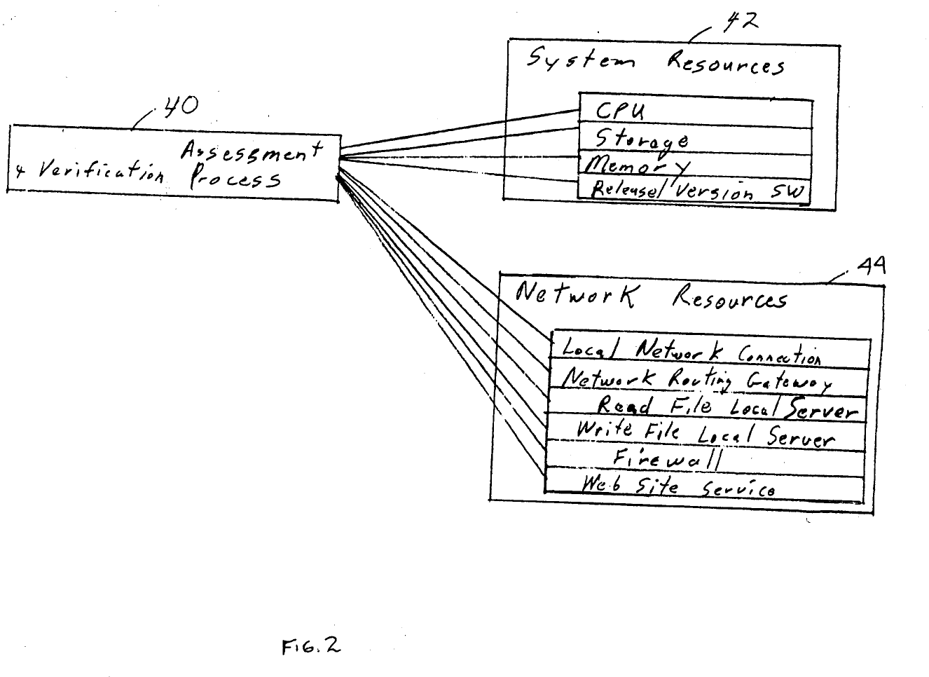

FIG. 2 is a schematic diagram of the tasks performed by an assessment and verification process 40 in one embodiment of the invention. The assessment and verification process 40 receives a set of tasks to be performed as part of an assessment profile. These tasks may be broken down into system resources tasks 42 and network resources tasks 44. Some examples of system resources tasks include:

1) assess a CPU (central processing unit) for sustain 60% or higher usage over a five minute interval;

2) assess the free disk space available for at least 200M Bytes;

3) assess the free memory over a five minute interval for at least 5M Bytes;

4) assess the operating software release version and determine if a newer version is available.

Some examples of the network resources tasks include:

1) assess the connection speed to the local data network 16 (FIG. 1) for a sustained 10M Bit/second or higher transmission rate over a five minute interval;

2) assess the availability of a network routing gateway over a ten minute interval;

3) assess the availability of reading a data file from a network file share on a local server 26 (FIG. 1) over a thirty minute interval;

4) assess the availability of writing a data file to a network file share on a local server 26 (FIG. 1) over a thirty minute interval;

5) assess the availability of a network firewall interconnect system 28 (FIG. 1) over a fifteen minute interval;

6) assess the availability of a web site service (i.e., a URL) on a remote server 32 (FIG. 1) over a 45 minute interval.

For each of the network resources tasks there is an associated maximum allowable time between direct tests. This maximum allowable time is called a reflective test limit. The reflective test limit may be measured in other ways such as number of tests.

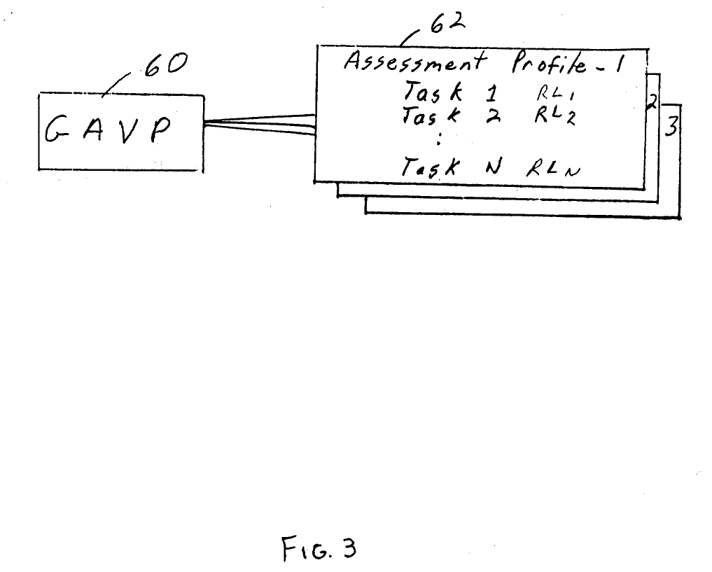

FIG. 3 is a diagram of a group assessment and verification process 60 coupled to assessment profiles 62 in accordance with one embodiment of the invention. The group assessment and verification process 60 provides the assessment profiles 62 to the appropriate assessment and verification processes. The assessment profiles 62 are stored in the database 22 (FIG. 1). The assessment profiles 62 define a number of tasks for a computer system to perform. The tasks detailed with respect to FIG. 2 are representative of the type of tasks defined in an assessment profile. Associated with each of the tasks is a reflective test limit.

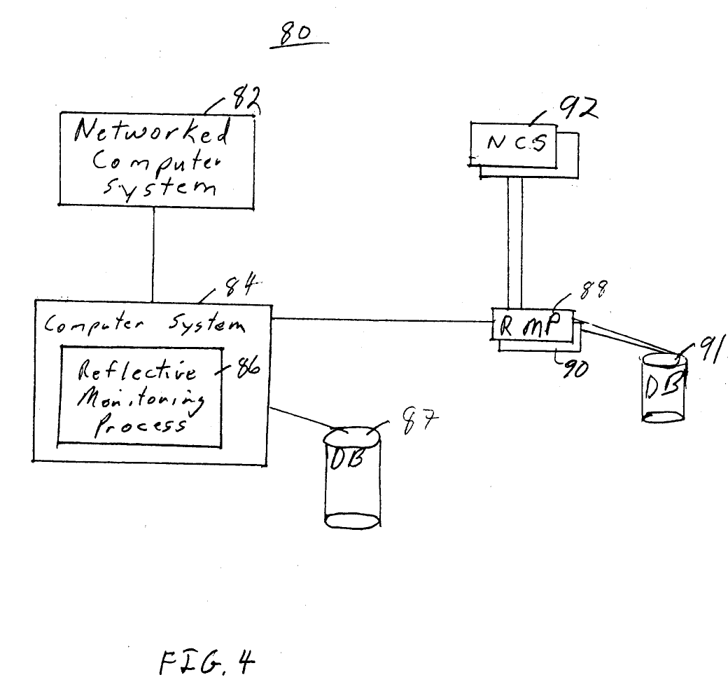

FIG. 4 is a block diagram of a system 80 for reflective system and network performance assessment and verification in accordance with one embodiment of the invention. A networked computer system 82 is coupled to a computer system 84 running a reflective monitoring process 86. A networked computer system 82 is a standard computer network and may include all the items described with respect to FIG. 1. The computer system 84 is coupled to a database 87. The database 87 may store a variety of information, including direct test results. The reflective monitoring process (RMP) 86 may be coupled to other RMPs 88, 90. The RMPs 88, 90 are coupled to multiple networked computer systems 92. The RMPs 88, 90 are coupled to a database 91. Note that multiple RMPs may be coupled to a single NCS or multiple NCS may be coupled to a single RMP. These various configurations are all allowed and may occur for historical, business or technical reasons. The RMPs 86, 88 & 90 may share test results.

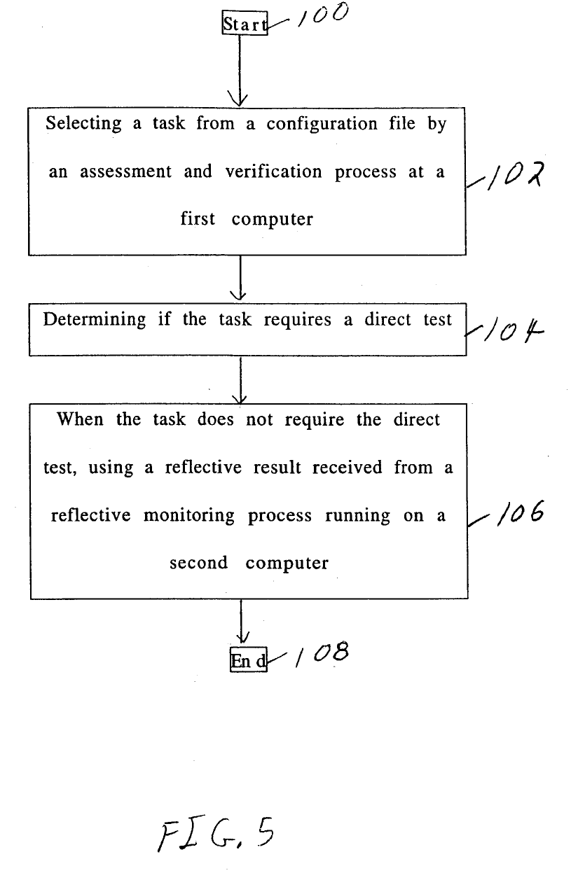

FIG. 5 is a flow chart of the steps used in a method for reflective system and network performance assessment and verification in accordance with one embodiment of the invention. The process starts, step 100, by selecting a task from a configuration file by an assessment and verification process at a first computer at step 102. Next it is determined if the task requires a direct test at step 104. When the task does not require a direct test at step 106, a reflective result from the reflective monitoring process running on the second computer is used which ends the process at step 108. When the task does require the direct test, the direct test is performed to form a direct result. The direct result is transmitted to the reflective monitoring process which runs on the second computer.

In one embodiment, an elapsed time since a last direct test is determined. When the elapsed time is greater than a predetermined time, the direct test is required. When the elapsed time is not greater than a predetermined time then the direct test is not required.

In one embodiment, a test is performed by the reflective monitoring process. The reflective result of the test is transmitted to the assessment and verification process.

Thus there has been described a system and method for reflective system and network performance assessment and verification that provides results from an end user's point of view and limits the traffic load on a computer network.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for reflective system and network performance assessment and verification, comprising:
a plurality of computer systems each running an assessment and verification process;
a data network coupled to each of the plurality of computer systems; and
a reflective monitoring process running on a computer system coupled to the data network, the reflective monitoring process transmitting a test and measurement information to one of the assessment and verification processes.

2. The system of claim 1, wherein one of the assessment and verification processes has a requirement to test a connection periodically.

3. The system of claim 2, wherein the requirement includes a maximum time between direct tests.

4. The system of claim 3, wherein the one of the assessment and verification processes receives a reflective test result from the reflective monitoring process.

5. The system of claim 2, wherein the one of the assessment and verification processes performs a direct test and transmits a result to the reflective monitoring process.

6. The system of claim 1, wherein the reflective monitoring process performs a direct test and transmits the results a group assessment and verification process.

7. The system of claim 1, wherein the test and measurement information includes a server test.

8. A system for reflective system and network performance assessment and verification, comprising:
a networked computer system including a first computer system running an assessment and verification process; and
a reflective monitoring process running on a second computer coupled to the networked computer system, the reflective monitoring process performing a test on the networked computer system and transmitting a test result to the assessment and verification process.

9. The system of claim 8, wherein the test is database server test.

10. The system of claim 8, wherein the assessment and verification process has a network testing requirement that includes a reflective test limit.

11. The system of claim 10, wherein the assessment and verification process performs a direct test and reports a direct test result to the reflective monitoring process.

12. The system of claim 8, wherein the networked computer system further includes a plurality of computers each running an assessment and verification process.

13. The system of claim 8, further including a second networked computer system coupled to the reflective monitoring process.

14. The system of claim 8, further including a second reflective monitoring process coupled to the networked computer system.

15. A process for reflective system and network performance assessment and verification, comprising the steps of:
a) selecting a task from a configuration file by an assessment and verification process at a first computer;
b) determining if the task requires a direct test; and
c) when the task does not require the direct test, using a reflective result received from a reflective monitoring process running on a second computer.

16. The process of claim 15, further including the steps of:
d) when the task does require the direct test, performing the direct test to form a direct result.

17. The process of claim 16, further including the steps of:
e) transmitting the direct result to the reflective monitoring process running on the second computer.

18. The process of claim 15, wherein step (b) further includes the steps of:
b1) determining an elapsed time since a last direct test,
b2) when the elapsed time is greater than a predetermined time, requiring the direct test.

19. The process of claim 18, further including the step of:
b3) when the elapsed time is not greater than a predetermined time then the direct test is not required.

20. The process of claim 15, wherein step (c) further includes the steps of:
c1) performing a test by the reflective monitoring process;
c2) transmitting the reflective result of the test to the assessment and verification process.
